(19) United States
(12) Patent Application Publication
(10) Pub. No.: US 2011/0158884 A1
(43) Pub. Date: Jun. 30, 2011

(54) Preparation Of Organohalosilanes and Halosilanes

(76) Inventors: David Charles Bentley, Cardiff (GB); Claire Britton, Cardiff (GB); Joseph Pete Kohane, Indianapolis, IN (US)

(21) Appl. No.: 12/995,931

(22) PCT Filed: Jun. 4, 2009
(86) PCT No.: PCT/US2009/003392

§ 371 Date: Feb. 24, 2011

Related U.S. Application Data
(60) Provisional application No. 61/058,773, filed on Jun. 4, 2008.

(51) Int. Cl. C01B 33/107; C07F 7/12; C07F 7/16

(52) U.S. Cl. 423/342; 556/473; 556/472

(57) ABSTRACT

A semi-continuous process for producing organohalosilanes or halosilanes in a fluidised bed reactor, from silicon-containing contact mass, comprising removing silicon-containing contact mass that has been used in said reactor by: (i) elutriation in an unreacted organohalide or hydrogen halide stream and/or an organohalosilane or halosilane product stream and (ii) direct removal using gravitational or pressure differential methods and returning removed silicon-containing contact mass to the fluidised bed reactor and/or fresh silicon-containing contact mass. When used for producing organohalosilanes (e.g. alkylhalosilanes) the silicon-containing contact mass may contain catalysts and promoters in addition to silicon.

### BACKGROUND OF THE INVENTION

The invention disclosed and claimed herein describes improved methods for the preparation of organohalosilanes (e.g. alkylhalosilanes) or halosilanes primarily by the removal of substantially spent components and/or impurities from reactors to allow for enhanced reactivity of the silicon-containing starting materials which are the raw materials for the production of silicon-based compounds, for example, alkylhalosilanes such as dimethyldichlorosilane, methyldichlorosilane, and other halosilanes such as trichlorosilane, which chlorosilanes are useful in the preparation of valuable silicon-containing products.

Organohalosilanes, that form the starting materials for the entire silicone products industry, are produced in a process generally referred to as the Direct Process. This process is well known to the man skilled in the art. The synthesis process involves activating a mixture (often referred to as the contact mass) comprising metallic silicon, a suitable catalyst (usually a copper catalyst) and co-catalysts/promoters, and introducing an organohalide (e.g. an alkyl halide) or hydrogen halide into the activated contact mass to obtain a gas-solid direct contact between metallic silicon and alkyl halide or hydrogen halide resulting in the production of alkylhalosilanes and halosilanes respectively. As both the alkyl halide or hydrogen halide and the resulting products are gases, the use of fluidised bed reactors is generally preferred for the Direct Process. Two of the earliest and most fundamental patents relating to the Direct Process are U.S. Pat. No. 2,380,995, directed to the chemical process in general and U.S. Pat. No. 2,389,931, directed to the use of fluidised bed reactors in the Direct Process.

The most important alkylhalosilane product of the Direct Process is dimethyldichlorosilane, although other compounds are also produced. Dependent on the reaction conditions and starting materials the additional compounds can include a variety of silanes for example, methyltrichlorosilane, dimethylchlorosilane, trimethylchlorosilane, tetramethylsilane, methyldichlorosilane, other chlorosilanes and various methylchlorodisilanes. Direct Process residue is also produced. This is a combination of numerous compounds which are present in minor amounts and which have lower commercial utility. Typically Direct Process residue consists of comparatively high boiling point by-products having normal boiling points greater than about 71° C. These residual compounds are well described in the literature.

There is constant effort in the industry to enhance the Direct Process for producing methylchlorosilanes so that it is more selective in terms of producing dimethyldichlorosilane, and is more efficient at providing higher yields thereof at a faster rate. In addition, intimate control of the process is desired such that when compounds other than dimethyldichlorosilane are desired, such as methyldichlorosilane, the process can be controlled to generate these compounds in higher yields.

Unfortunately, the current commercial Direct Process is difficult to operate on a continuous basis as it becomes increasingly difficult to control the compounds obtained as time progresses. This is thought to be due to the accumulation of impurities in the fluidised bed reactor as the silicon metal is consumed and thus, the process has to be shut down periodically and the fluidised bed reactor's contents purged, regenerated, refurbished or discarded in order to return the process to an acceptable yield level and rate of reaction, and more importantly, to the selective formation of dimethyldichlorosilane.

Chemical grade silicon typically contains about 0.4% weight Fe, 0.15% weight Al, 0.08% weight Ca and 0.03% weight Ti. The presence of these impurities is thought to be a main contributory factor to the decrease in selectivity. These non-silicon metals can also form a range of intermetallic species such as FeSi₂, CaSi₂, FeSi₂Ti, Al₂CaSi₂, Al₈Fe₅Si₇, Al₃FeSi₂, Al₆CaFe₄Si₈, FeSi_{2.4}Al, and the like, some of which are thought to be at least partially the cause of the decrease in selectivity and reaction rate.

Also with regard to the silicon metal, it has been identified that the particle size distribution of the particles used can have a significant effect on the process as described in U.S. Pat. No. 5,312,948, U.S. Pat. No. 5,783,721 and U.S. Pat. No. 5,986,123.

A further publication regarding the various factors affecting the degree of usage of the silicon in the Direct Process can be found in M. G. R. T. de Cooker, et. al., “The Influence of Oxygen on the Direct Synthesis of Methylchlorosilanes”, Journal of Organometallic Chemistry, 84, (1975), pp. 305 to 316, in which de Cooker discloses that during the Direct Process synthesis, a gradual deactivation of the contact mixture surface occurs. He speculates that this deactivation may be caused by a number of factors. For example, the deposition of carbon and carbonaceous products may block part of the surface. Furthermore, the activity can be decreased by decreasing the content of the promoters on the contact mixture surface per se, for example, as caused by the evaporation of ZnCl₂, by the accumulation in the reactor of elements present as contaminants in the silicon, for example, iron, by the increase of free copper on the surface causing enhanced cracking, or by the blocking of the reactive sites by reaction of the contact mixture with traces of oxygen, yielding silicon and copper oxides.

The selectivity of the formation of the chlorosilanes has been defined in U.S. Pat. No. 3,133,109, as the mass ratio of organotrichlorosilane (T) to diorganodichlorosilane (D) (the T/D ratio. It is generally desired to have a T/D ratio of below about 0.35 in an industrially-suitable process. The modern objective is to minimize the T/D ratio. Usually as the reaction proceeds starting with fresh silicon, fresh catalyst and fresh promoter particles (forming the contact mass), the T/D ratio drops to a value of from 0.1 to 0.2 where it stays for a long period of time and then slowly increases to above 0.2 and the higher values remain unless it is retarded. Usually the method of retarding the increase of the T/D ratio is to insert or replace some of the spent or used contact mass particles in the reactor bed with fresh silicon, catalyst and promoter particles.

Historically, when the contact mass in the reactor has been used for some time and the T/D ratio has gone beyond permissible levels, the contact mass in the reactor was considered poisoned and was discarded. Fresh silicon, catalyst and promoter particles were then inserted into the reactor.

Thus, there is a need to overcome the impurity build up (accumulation) and allow the reaction to run longer, with greater efficiency and increased yields, with better control over the products that are produced. Several references described below discuss impurities and their removal by withdrawing a stream from the reactor, separating an impurities-lean portion and returning it to the reactor. The term “content ratio” as used herein is calculated as the ratio of the weight percent of a given element in an impurities-rich fraction divided by the weight percent in an impurities-lean fraction. A content ratio of 1.0 indicates that there are equal concentrations of the given element in rich and lean fractions and thus no separation occurred for that element.

It is known small contact mass particles can be removed from the reactor by entrainment in the gaseous stream exiting the reactor. Henceforth this will be referred to as elutriation. U.S. Pat. No. 4,307,242 describes the elutriation of small particles of contact mass from the fluidised bed reactor during the course of the process. This results in a decrease in the impurity accumulation within the reactor. Subsequent to their removal in U.S. Pat. No. 4,307,242 the particles are separated from the product gas stream and are subjected to a size classification method using for example an aerodynamic centrifugal classifier or the like.

Similarly U.S. Pat. No. 4,281,149, by Shade, describes a means of abrading a portion of the silicon particles of less than 40 microns average diameter in size and which had been elutriated from the reactor. The abrading process enables the reuse of the silicon metal, if required, by removing the silicon metal “surface poisoning” layer and fresh reaction surfaces are exposed. Whenever used herein, the term “abraded” or “abrasion” means the processes set forth in Shade, which disclosure is incorporated herein by reference for what it teaches about the abrasion of solid particles from reactors.

In GB 673436 there is provided a process for the manufacture of alkylhalosilanes in which the contact mass in the form of granules, lumps or pills is stacked in layers in a fixed bed reactor vessel and alkylhalide passes through the contact mass from bottom to top. Substantially spent silicon (about 90% of whose silicon has been consumed) is removed from the bottom and is replaced by material at the top of the contact mass. Discharging of the contact mass was performed by a “discharge worm” or “bucket wheel”.

### SUMMARY OF THE INVENTION

It has been found that comminuted silicon metal powders of relatively low particle sizes of below 150 μm, preferably below 85 μm are easily fluidised, which is contrary to standard fluidised bed theory i.e. the Geldart Classification of Powders identifies such powders as cohesive. Fluidisation regimes for fluidised bed reactors are discussed by D. Geldart in Gas Fluidisation Technology (1986), p. 183. Relying on Geldart's definitions contrary to this finding it has become apparent that bubbling and turbulent fluidization regimes are achieved with these relatively small particle sizes at a relatively high fluidizing gas velocity and that the expected rate of the elutriation of silicon metal particles and the like in the product gas stream is significantly lower than the skilled man would expect e.g. by theoretical calculations using, for example fluidisation models developed by pilot-scale industrial research establishments. This means that reactors utilizing low particle size silicon metal are surprisingly less able to rely on elutriation of small contact mass particles than processes using larger particle sized silicon metal in a fluidised bed to remain efficient. Reactors containing such small contact mass particles do not remain efficient for long periods i.e. they relatively quickly have a T/D ratio of about 0.35 or greater resulting the necessity of having to stop the reactor, discard the reactor's contact mass and replenishing the reactor with fresh silicon, and when required, catalyst and/or promoter particles.

The inventors have now been able to determine that it is possible to remove and optionally recover and recycle contact mass from a fluidised bed reactor for the Direct Process, while significantly extending the period of time the T/D ratio is maintained at acceptable levels even when silicon metal powders of relatively low particle sizes are used as described above. The processes disclosed and claimed herein control impurity accumulation in the fluidised bed of the reactor and enhance the reaction therein to provide a more efficient process, better selectivity, better process control and increased productivity because of longer run times for the reaction.

### DETAILED DESCRIPTION OF THE INVENTION

In accordance with the present invention there is provided a process for the preparation of organohalosilanes or halosilanes, the process comprising:

(I) providing a fluidised bed reactor having an entrance and an exit;
(II) charging the fluidised bed reactor with the following ingredients:
(i) comminuted silicon;
(ii) at least one catalyst for a Direct Process reaction, provided that when HCl is fed to the reactor in step (III) no catalyst is added;
(iii) at least one promoter for the Direct Process reaction, provided that when HCl is fed to the reactor in step (III) no promoter is added;
   (III) thereafter, providing an organohalide or hydrogen halide to the reactor to form a fluidised bed in the reactor;
   (IV) allowing the ingredients to interact and react to produce organohalosilanes or halosilanes at a desired ratio and at a desired rate;
   (V) enabling the organohalosilanes or halosilanes to leave the fluidised bed reactor whereby the organohalosilanes or halosilanes and unreacted organohalide or hydrogen chloride elutriate a proportion of the particulate contact mass;
   (VI) periodically or continuously removing contact mass from the fluidised bed reactor by direct removal at any location from beneath the surface of the fluidised bed using gravitational or differential pressure techniques; and
   (VII) replacing the contact mass removed in steps (V) and (VI) with fresh silicon.

When it is sought to produce a halosilane product the essential ingredients introduced into the fluidised bed in steps (II) and (III) above are the comminuted silicon and hydrogen halide. Usually the hydrogen halide is hydrogen chloride (HCl). When it is sought to produce an organohalosilane product, catalyst and promoter are required in addition to the silicon and organohalide. Typically the halide, when present, is a chloride. Catalyst and/or promoter may optionally be introduced together with the fresh silicon in step (VII). Optionally the fresh silicon may be at least partially replaced by returning removed silicon-containing contact mass or a mixture of both fresh silicon containing mass and removed silicon containing contact mass to the fluidised bed reactor.

In a further embodiment of the present invention there is provided a semi-continuous process for producing organohalosilanes or halosilanes in a fluidised bed reactor, from silicon-containing contact mass, comprising removing silicon-containing contact mass that has been used in said reactor by:
(i) elutriation in an unreacted organohalide or hydrogen halide and organohalosilane or halosilane (respectively) product stream and
(ii) direct removal using gravitational or pressure differential methods and replacing the removed silicon-containing contact mass with fresh silicon fed to the reactor.

Optionally in the case of organohalosilane production, requiring both catalyst and promoter, fresh catalyst and/or promoter may also be introduced with the fresh silicon. Typically the halo group is a chloride and each organo group is an alkyl group, which may be the same or different. Optionally the fresh silicon may be at least partially replaced by returning removed silicon-containing contact mass or a mixture of both fresh silicon containing mass and removed silicon containing contact mass to the fluidised bed reactor.

In a still further embodiment of the present invention there is provided a semi-continuous process for producing organohalosilanes or halosilanes in a fluidised bed reactor, from silicon-containing contact mass, comprising removing silicon-containing contact mass that has been used in said reactor by:
(i) elutriation in an unreacted organohalide or hydrogen halide stream and/or an organohalosilane or halosilane product stream and
(ii) direct removal using gravitational or pressure differential methods and returning removed silicon-containing contact mass to the fluidised bed reactor.

It is to be understood that in the case when organohalosilanes are being produced the removed silicon-containing contact mass will contain both catalyst and/or promoter as well as silicon. The halo group will typically be a chloride and each organo group is an alkyl group, which may be the same or different. Optionally the removed silicon-containing contact mass may be at least partially replaced by fresh (previously unused) silicon-containing contact mass or a mixture of both fresh silicon containing mass and removed silicon containing contact mass to the fluidised bed reactor.

The semi-continuous processes additionally involve steps as previously discussed i.e. charging a fluidised bed reactor with the following ingredients:

(i) comminuted silicon; and when required
(ii) at least one catalyst for a Direct Process reaction; and
(iii) at least one promoter for the Direct Process reaction;
and thereafter, providing an organohalide or hydrogen halide (dependent on the final product sought) to the reactor to form a fluidised bed in the reactor. The ingredients are then left for a predetermined period of time to interact and react to produce organohalosilanes or halosilanes at a desired ratio and at a desired rate. After this period of time the products i.e. gaseous organohalosilanes or halosilanes are removed from the reactor.

As discussed above, contrary to industrially-developed fluidisation models, elutriation alone is not able to purge sufficient contact mass out of the fluidised bed to stabilize reactor performance. The inventors have found that a combination of both elutriation and periodic or continuous direct discharge of contact mass from the fluidised bed significantly improves the efficiency of the Direct Process and is able to maintain the desired T/D ratio for an extended period of time.

The reaction of organohalides (e.g. alkylhalides) or hydrogen halides with particulate silicon-containing contact mass is known to be a surface reaction. Organohalides, e.g. alkylhalides or hydrogen halides react with silicon or with catalytically activated silicon surfaces. More available silicon surface gives more potential for reaction in a given volume, so reaction rate is related to the specific surface area of particles available. Smaller particles have high specific surface areas and react away quickly while larger particles have a lower specific surface area and a corresponding lower reaction rate. Furthermore, since the silicon-containing particles spend a finite residence time in the reactor, faster reacting small particles are more likely to be consumed to give high silicon conversion and consequently fewer unreacted “spent” silicon-containing particles.

The comminuted silicon referred to is intended to mean silicon which has been reduced to a powder by e.g. attrition, impact, crushing, grinding, abrasion, milling or chemical methods. In the case of silicon powder grinding methods are often preferred. Typically the comminuted silicon powder utilized is up to a maximum size of about 150 μm preferably up to a maximum size of about 85 μm.

The described silicon powder particle size distributions can be characterized by three percentile sizes. Each percentile describes the particle size in microns below which a mass percentage of the size distribution resides: i.e. “10th percentile”—10 percent of the mass distribution is smaller than the 10th percentile size: “50th percentile”—50 percent of the mass distribution is smaller than the 50th percentile size: and “90th percentile”—90 percent of the mass distribution is smaller then the 90th percentile size. It is noted that the “particle size” is given by a mass based particle size distribution as measured by sedimentation techniques, or through laser diffraction/scattering processes with appropriate correction to sedimentation techniques using particle size standards.

Preferably the silicon particle size for the present process is up to 150 μm. A preferred silicon particle size is up to 85 μm. A more preferred silicon particle size is up to 50 μm. It is preferred that the silicon powder have a particle size mass distribution characterized by a 10th percentile of 1 to 5 μm, a 50th percentile of 5 to 25 μm, and a 90th percentile of 25 to 60 μm. In a still more preferred embodiment, the particle size mass distribution is characterized by a 10^{th} percentile from 1 to 4 μm, a 50^{th} percentile from 7-20 μm, and a 90^{th} percentile from 30-45 μm. Alternatively the silicon powder may have a particle size mass distribution characterized by a 10th percentile of 2.1 to 6 μm, a 50th percentile of 10 to 25 μm, and a 90th percentile of 30 to 60 μm. In a still more preferred embodiment, the particle size mass distribution is characterized by a 10^{th} percentile from 2.5 to 4.5 μm a 50^{th} percentile from 12-25 μm, and a 90^{th} percentile from 35-45 μm.

Standard methods for producing particulate silicon can be used, for example, the use of a roller or ball mill to grind silicon lumps. The powdered silicon may be further classified as to particle size distribution by means of, for example, screening or use of mechanical aerodynamic classifiers such as a rotating classifier.

The method of the invention uses a copper catalyst when the process is utilised to prepare organohalosilanes. For the copper catalyst, any form of copper may be used, for example, elemental copper such as granular copper powder and stamped copper, copper alloys such as Cu—Zn, Cu—Si and Cu—Sb, and copper compounds such as cuprous oxide, cupric oxide, and copper halides. When required, the copper catalyst is loaded in the reactor along with metallic silicon powder. When present, the loading of the copper catalyst is preferably about 0.1 to 10 parts, especially about 2 to 8 parts by weight of copper per 100 parts by weight of the metallic silicon powder in the reactor charge. Most preferably 5 to 8 parts by weight of copper per 100 parts by weight of the metallic silicon powder in the reactor charge. Furthermore, where possible the levels of catalyst are maintained at these levels throughout the reaction process through the aforementioned introduction of new catalyst or through their introduction of catalyst as part of the reintroduced spent bed.

In addition to copper, the catalyst composition may optionally employ other materials as accelerators or co-catalysts, termed promoters. These optional additives (promoters) may include any elements or their compounds known to those skilled in the art as promoters of the Direct Process. These may include, but are not restricted for example, phosphorous, phosphorous compounds, zinc, zinc compounds, tin, tin compounds, antimony, antimony compounds and arsenic and arsenic compounds, cesium and cesium compounds, aluminum and aluminum compounds and mixtures thereof. Examples of such promoter materials are described in, for example, U.S. Pat. No. 4,602,101, U.S. Pat. No. 4,946,978, U.S. Pat. No. 4,762,940 and U.S. Pat. No. Re. 33,452, each of which is incorporated by reference herein. Preferably, when present, the catalyst levels in the contact mass are maintained at a relatively constant level by introduction of new catalyst together with new comminuted silicon in accordance with the present invention or used catalyst is re-introduced as part of the re-introduction of removed silicon-containing contact mass.

When required, i.e. when preparing organohalosilanes, a preferred catalyst composition for the present process comprises on an elemental basis by weight: 0.1 to 10 weight percent copper based on silicon present in the process. When present the optional promoters may comprise one or more of the following in the amounts given below:

50 to 10,000 parts per million (ppm) zinc,
5 to 200 ppm tin, antimony or arsenic,
10 to 1000 ppm cesium, and
25 to 2,500 ppm phosphorous.
200 to 10000 ppm aluminum
based on silicon present in the process. Preferably, when present, the promoter levels in the contact mass are maintained at a relatively constant level by introduction of new promoter together with new comminuted silicon in accordance with the present invention or used promoter is re-introduced as part of the re-introduction of removed silicon-containing contact mass. Preferably the ranges are maintained throughout the process by introduction of new promoter or reintroduction of promoter, for example preferably the ratio of copper catalyst to zinc is maintained throughout the process at a Cu:Zn ratio of >100:1. In such a case copper is preferably also maintained at concentrations of greater than 5 parts by weight of copper per 100 parts by weight of the metallic silicon powder in the reactor charge when the ratio of copper catalyst to zinc.

The contact mass or metallic silicon powder may optionally be heated for a certain time in an inert atmosphere at a temperature of up to 350° C., preferably 200 to 280° C. before it is subject to reaction. Preheating improves the fluidity and enables stable operation.

The mean (50^{th} percentile) particle diameter of the contact mass can be controlled mainly by regulating that of the metallic silicon powder as the raw material. For the regulation in mean particle diameter of the metallic silicon powder, various pulverisers such as roller mills, sand mills and ball mills may be used.

From the milled metallic silicon, a fraction of the desired particle size may be collected as by partly-inerted gas elutriation. Since the metallic silicon powder collected by such elutriation has a very sharp particle size distribution, extra steps of separation and particle size regulation are unnecessary, which is advantageous for industrial manufacture.

When organic halides are utilised as the starting material, the organic halides which react with silicon in the process of the present invention are gaseous and have the formula:

RX (1)

where R is a monovalent organic radical, such as a hydrocarbon radical selected from the class consisting of alkyl radicals, e.g., methyl, ethyl, propyl, butyl, octyl, etc. radicals; aryl radicals, e.g., phenyl, naphthyl, tolyl, xylyl, etc. radicals; aralkyl radicals, e.g., phenylethyl, benzyl, etc. radicals; alkenyl radicals, e.g., vinyl, allyl, etc. radicals; alkynyl radicals, e.g., ethynyl, propynyl, etc. radicals; cycloalkyl radicals, e.g., cyclohexyl, cycloheptyl, etc. radicals; and cycloalkenyl radicals, e.g., cycloheptenyl, cyclohexenyl radicals, etc and their mixtures and where X is a halide selected from chlorine, bromine and fluorine. In one preferred embodiment RX is RCl. Among the preferred organic chlorides within the scope of Formula 1 can be mentioned for example, chlorobenzene, methyl chloride and ethyl chloride, with the preferred specific organic chloride being methyl chloride.

When X is a chloride group, the organic chloride (of Formula (1)) reacts with elemental silicon, and the products formed consist primarily of organochlorosilanes having the formula:

RₙSiCl₄₋ₙ (2)

where R is as previously defined and n is an integer equal to from 0 to 4 or alternatively from 0 to 3. Specific examples of organochlorosilanes include methyltrichlorosilane, dimethyldichlorosilane and trimethylchlorosilane which are formed from methyl chloride; phenyltrichlorosilane, diphenyldichlorosilane and triphenylchlorosilane which are formed from chlorobenzene; and various other organochlorosilanes such as diethyldichlorosilane, dibenzyldichlorosilane, vinyltrichlorosilane, etc. which are formed from the appropriate organic chloride.

When hydrogen halides e.g. hydrogen chloride are utilised as the starting material reacts with elemental silicon, the products formed consist primarily of chlorosilanes having the formula:

HₙSiX₄₋ₙ (3)

where X is a halide selected from chlorine, bromine and fluorine and n is an integer equal to from 0 to 4, alternatively 0 to 3. Specific examples of e.g. chlorosilanes include tetrachlorosilane, trichlorosilane, dichlorosilane and chlorosilane.

The organohalide or hydrogen halide reactant may be pre-heated and gasified before it is fed into the reactor.

The Direct Process reaction temperature may be controlled in the range of 250 to 350° C. as is conventional, preferably in the range of 280 to 340° C. The Direct Process reaction pressure may be controlled in the range of 0 to 10 atmospheres gauge, preferably in the range of 1 to 5 atmospheres gauge.

The present invention is a process for the manufacture of organohalosilanes described by formula

RₐH_{b}SiX_{4-a-b} (4)

with a fluidised-bed of particulate silicon where the particulate silicon has a size of up to about 150 μm, preferably up to about 85 μm in the presence of a catalyst composition as described above, at a temperature within a range of about 250° C. to 350° C.; where each R is independently as hereinbefore described; a=0, 1, 2, 3, or 4; b=0, 1, 2, 3 or 4; (alternatively b may=0, 1, 2 or 3), a+b=1, 2, 3 or 4; and X is a halogen, usually chlorine. The preferred alkylhalosilanes are those having the formula R₂SiX₂, where R is methyl or ethyl and X is chlorine. The most preferred alkylhalosilane is dimethyldichlorosilane, i.e. (CH₃)₂SiCl₂.

Contact of the organohalide with the particulate silicon is affected in a fluidised bed of particulate silicon. The process can be conducted in standard type reactors for reacting a fluidised bed of particulates with a gas. The bed can be fluidised using the organohalide or hydrogen halide as the fluidizing media or using a mixture of the organohalide or hydrogen halide with a gas which is inert in the process as the fluidizing media. Examples of suitable inert gases include nitrogen gas, helium gas, and argon gas and mixtures thereof, of these nitrogen gas is clearly the most cost effective. The mass flux of the fluidising gas can vary according to the invention. Typical and preferable ranges of mass flux are known in the art.

Preferably for optimal efficiency of the process the particulate silicon has a closely defined particle size or particle size distribution as described in U.S. Pat. No. 5,312,948. For purposes of the present invention process efficiency is defined as the cumulative silicon conversion.

$$Cumulative silicon conversion = \frac{\begin{matrix}Cumulative mass of \\ silicon metal reacted\end{matrix}}{\begin{matrix}Cumulative mass of silicon \\ metal fed to the reactor\end{matrix}}$$

When using the Direct Process to produce organohalosilanes the commercial aim is to maintain a cumulative silicon conversion in the range of from >50 to <100%, preferably of from 70% to about 95%. This can be maintained through removal of a portion of the contact mass during the continuous phase of the process while fresh silicon, catalyst and promoter particles are still being fed to the reactor. The continuous phase of the process is the part of the process wherein contact mass is periodically or continuously being removed and is being replaced with fresh silicon and optionally, catalyst and promoters, as hereinbefore described. The inventors found that reaction performance can be maintained longer than if the portion is not removed. The overall goal of near 100%, i.e. from about 98% up to 100% overall silicon conversion is still approached by means of returning previously removed silicon containing solid portions late in the continuous phase of the process as this results in the recovery of the valuable silicon materials they contain.

However a significant problem with the use of such small particulate silicon is the fact that contrary to expectations the amount of contact mass particles being elutriated from the fluidised bed is insufficient for the fluidised bed to maintain its overall process efficiency for extended periods of time.

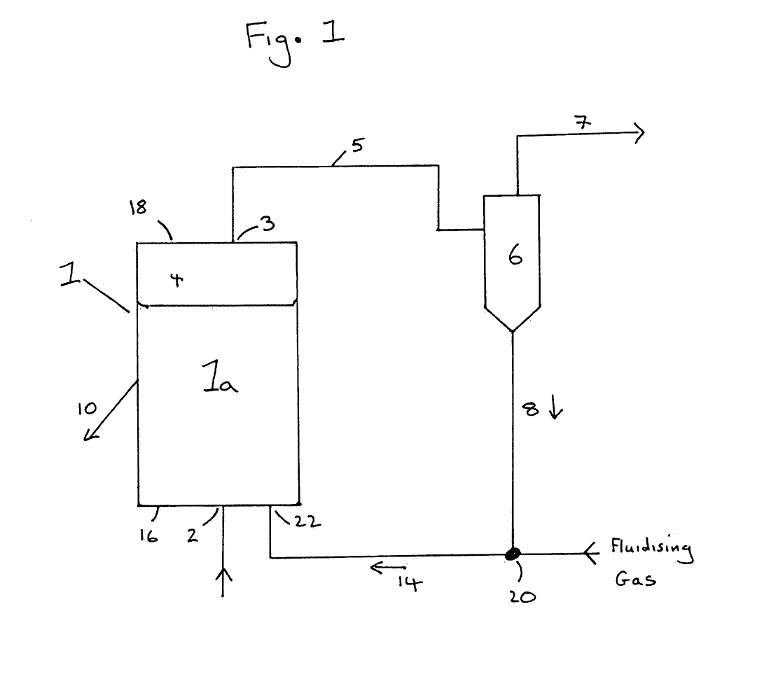

FIG. 1 is a schematic diagram of a process and apparatus in accordance with the present invention. As shown by way of example, there is provided a fluidised bed reactor 1 having an entrance 2 in base wall 16 and an exit 3 in top wall 18. Chemical grade silicon, catalyst and promoter particles are introduced into the fluidised bed reactor both prior to use and thereafter through entrance 2. Organohalide (typically alkyl halide) gas or hydrogen halide gas is introduced into the fluidised bed reactor 1 via entrance 2 from a source (not shown). This creates a fluidised bed 1a in the majority of the reactor 1 and a head space 4 (region of the reactor predominantly above the upper surface of the fluidised bed). The fluidised bed is designed such that head space 4 is above the bulk particulate contents of the fluidised bed which enables larger solids to disengage from the gas stream creating the fluidity of the bed. Once the process has been initiated replacement silicon particles and optionally catalyst and/or promoter particles are introduced into the fluidised bed reactor 1 through entrance 2, at a suitable rate. Hence, in view of the head space 4 and the velocity of the fluidizing gas, typically only fines i.e. very small particles of silicon metal are being elutriated from the system. Exit 3 is designed to remove gaseous organohalosilane or halosilane product through pipework 5 and into separator 6. Separator 6 is designed to separate the gaseous product from any elutriated contact mass particles. The gaseous product and any remaining residual elutriated solids are then transferred to storage via pipeline 7 and the separated solids are directed from separator 6 through pipework 8 to joint 20 where it is intermixed with incoming organohalide or hydrogen halide, an inert gas or otherwise fed to the reactor and is then transferred along pipeline 14 to re-enter the base 16 of fluidised bed 1 through entrance 22. Periodically or continuously portions of the contact mass are extracted via pipeline 10 by direct removal, i.e. by means of gravity or by differential pressure. This extraction can take place at any elevation below the surface of the fluidised bed. As hereinbefore described, alternatively removed contact mass may be reintroduced. Hence, material from pipeline 10 may, if and/or when required be re-introduced into bed 1a. Alternatively material from separator 6 (described below) and pipeline 10 may be intermixed and then re-introduced into bed 1a.

Whilst in the above the separator was merely used to separate the product and the particulates and the particulates were returned directly to fluidised bed reactor 1, this is merely an example. The particulates can be transferred to storage or they can undergo the process described in U.S. Pat. No. 4,307,242 in which the particles are separated from the product gas stream and are subjected to a size classification method using for example an aerodynamic centrifugal classifier or the like. The content of U.S. Pat. No. 4,307,242 is hereby included in the description by reference. Furthermore the particulates separated in separator 6 can in a further alternative be abraded as described in U.S. Pat. No. 4,281,149, disclosure is incorporated herein by reference for what it teaches about the abrasion of solid particles from reactors.

Preferably the direct removal process lies on the use of a tap in pipeline 10, in order for particulates to be removed by gravity. Alternatively, any suitable differential pressure system may be utilised to draw off the particulates from the fluidised bed reactor 1 into pipework 10, examples may include suitable Venturi and/or eductor systems. The resulting extracted contact mass particles may again be transferred to fluidised bed reactor 1 or may be stored or may be treated as disclosed above utilizing the processes described in U.S. Pat. No. 4,307,242 and U.S. Pat. No. 4,307,242. Alternatively the resulting extracted contact mass particles may be fed any other suitable processes such as to other Direct Process reactors “in series” or to alternative synthesis reactors e.g. for reaction with hydrogen halides.

The inventors have identified that when reliant on elutriation alone an insufficient amount of contact mass particles are being removed in order to maintain efficiency. However, experiments indicate that, by introducing the step of additionally removing contact mass by way of direct removal, improvements are noted in that processes can be continuously used for up to 2 to 3 times longer than when the elutriation is the sole means of on-going removal of contact mass particles during the process, i.e. twice or three times the period of time between the need to shut down the process and the fluidised bed contents purged, regenerated, refurbished or discarded in order to return the process to an acceptable yield level and rate of reaction, and more importantly, to the selective formation of dimethyldichlorosilane.

The performance of the copper-catalysed Direct Process for the synthesis of organohalosilanes such as alkylhalosilanes or the synthesis of halosilanes can be improved when a portion of the fluidised bed, produced within a reactor fed with silicon-containing particles having a size range of up to 150 μm and preferably up to 85 μm, is purged from the reactor by combination of direct discharge of contact mass from the homogeneous fluidised mixture and elutriation of fines particles out of the fluidised mixture, to maintain cumulative silicon conversion above 50% and below 100% during part of the campaign while fresh silicon, catalyst and promoter particles are still being fed to the reactor. Industrially-developed fluidisation models predict that elutriation alone would be sufficient to provide the required purge rate but this does not occur with the silicon particles having the described particle size range. The contact mass particles can be directly discharged from the reactor by gravity or by differential pressure. The contact mass particles removed from the reactor can be stored, returned to the same reactor for further chlorosilane synthesis, fed to another for further chlorosilane or alternative synthesis or disposed.

### EXAMPLES

### (Comparative) Example 1

A fluidised bed reactor as depicted in FIG. 1 was charged with a mixture of comminuted silicon powder having a particle size mass distribution of approximately a 10th percentile of 2.1 to 6 μm, a 50th percentile of 10 to 25 μm, and a 90th percentile of 30 to 60 μm, copper catalyst as hereinbefore described and promoters as hereinbefore described. This particulate mixture was fluidized with methyl chloride gas. The organochlorosilane synthesis reaction was initiated by heating the fluidised mixture to within a temperature range maintained between 250 to 350° C. during the reaction. The reactor's inventory of contact mass was maintained by continually replacing the silicon (and optionally catalyst and/or promoter) which had been removed by the combination of the organochlorosilane synthesis reaction and the contact mass leaving the reactor system due to elutriation.

The T/D ratio of the organochlorosilane synthesis reaction products, was in the range as hereinbefore described, and was continually measured and used to determine the point at which the reaction was stopped by cooling the reaction mixture.

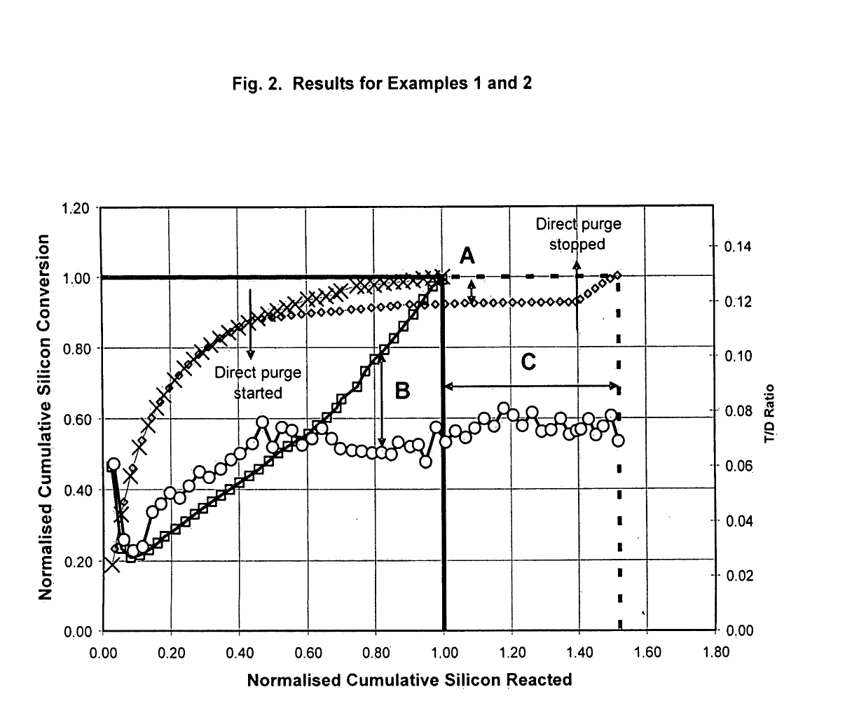

The results for Example 1, shown in Table 1 and FIG. 2, are expressed as the T/D ratio and a normalised cumulative silicon conversion as functions of the normalised cumulative silicon reacted. The maximum values of these three variables were coincident with the stopping point of the reaction.

TABLE 1

| | Normalised Cumulative | Normalised Cumulative | T/D |
|---|---|---|---|
| Mode | Silicon Reacted | Silicon Conversion | Ratio |
| Example 1 | 0.03 | 0.189 | 0.0600 |
| | 0.05 | 0.330 | 0.0305 |
| | 0.08 | 0.438 | 0.0271 |
| | 0.11 | 0.519 | 0.0281 |
| | 0.13 | 0.581 | 0.0300 |
| | 0.16 | 0.630 | 0.0324 |
| | 0.18 | 0.666 | 0.0348 |
| | 0.21 | 0.709 | 0.0374 |
| | 0.24 | 0.742 | 0.0401 |
| | 0.27 | 0.767 | 0.0428 |
| | 0.29 | 0.788 | 0.0449 |
| | 0.32 | 0.808 | 0.0473 |
| | 0.35 | 0.826 | 0.0496 |
| | 0.37 | 0.843 | 0.0517 |
| | 0.40 | 0.857 | 0.0542 |
| | 0.43 | 0.872 | 0.0566 |
| | 0.46 | 0.884 | 0.0590 |
| | 0.49 | 0.895 | 0.0619 |
| | 0.51 | 0.905 | 0.0649 |
| | 0.54 | 0.914 | 0.0672 |
| | 0.57 | 0.924 | 0.0692 |
| | 0.60 | 0.937 | 0.0718 |
| | 0.63 | 0.939 | 0.0750 |
| | 0.66 | 0.946 | 0.0779 |
| | 0.69 | 0.952 | 0.0814 |
| | 0.70 | 0.961 | 0.0846 |
| | 0.75 | 0.975 | 0.0890 |
| | 0.77 | 0.973 | 0.0947 |
| | 0.80 | 0.977 | 0.0991 |
| | 0.83 | 0.982 | 0.1026 |
| | 0.86 | 0.986 | 0.1067 |
| | 0.89 | 0.986 | 0.1112 |
| | 0.92 | 0.990 | 0.1154 |
| | 0.94 | 0.995 | 0.1210 |
| | 0.97 | 0.997 | 0.1257 |
| | 1.00 | 1.000 | 0.1282 |

### Example 2

The fluidized bed reactor as described in FIG. 1 was used to establish the organochlorosilane synthesis reaction as described in Example 1. However in Example 2 when an amount of comminuted silicon powder had been reacted equivalent to about 45% of the total cumulative silicon metal reacted in Example 1, a continual direct removal of the reactor's contact mass was made at a location beneath the surface of the fluidised bed. The rate of removal of material was controlled to maintain the cumulative silicon conversion at about 92% of the maximum cumulative silicon conversion attained in Example 1. The reactor's inventory of contact mass was maintained by continually replacing the silicon and selected catalysts and promoters which had been removed by the combination of the organochlorosilane synthesis reaction, the contact mass leaving the reactor system due to elutriation and the contact mass leaving the reactor system in the direct removal from beneath the surface of the fluidised bed. When an amount of comminuted silicon powder had been reacted equivalent to about 140% of the total cumulative silicon metal reacted in Example 1, the direct removal of the reactor's contact mass was stopped and the removed contact mass returned to the same reactor to increase the total cumulative silicon conversion to the same level as attained in Example 1.

The T/D ratio of the organochlorosilane synthesis reaction products was continually measured. The results for this example are expressed as a T/D ratio and a cumulative silicon conversion as functions of the cumulative silicon reacted. Normalized cumulative silicon conversion and cumulative silicon reacted are referenced to the Example 1 maxima.

TABLE 2

| | Normalised Cumulative | Normalised Cumulative | T/D |
|---|---|---|---|
| Mode | Silicon Reacted | Silicon Conversion | Ratio |
| Example 2 | 0.03 | 0.235 | 0.0609 |
| | 0.06 | 0.366 | 0.0336 |
| | 0.09 | 0.461 | 0.0296 |
| | 0.12 | 0.538 | 0.0311 |
| | 0.14 | 0.602 | 0.0436 |
| | 0.17 | 0.647 | 0.0465 |
| | 0.20 | 0.686 | 0.0504 |
| | 0.23 | 0.722 | 0.0486 |
| | 0.25 | 0.753 | 0.0529 |
| | 0.28 | 0.781 | 0.0580 |
| | 0.31 | 0.803 | 0.0561 |
| | 0.35 | 0.827 | 0.0591 |
| | 0.38 | 0.845 | 0.0624 |
| | 0.40 | 0.860 | 0.0647 |
| | 0.44 | 0.877 | 0.0683 |
| | 0.47 | 0.882 | 0.0762 |
| | 0.50 | 0.886 | 0.0670 |
| | 0.53 | 0.888 | 0.0742 |
| | 0.55 | 0.892 | 0.0731 |
| | 0.58 | 0.896 | 0.0677 |
| | 0.61 | 0.898 | 0.0701 |
| | 0.64 | 0.900 | 0.0738 |
| | 0.67 | 0.903 | 0.0700 |
| | 0.70 | 0.904 | 0.0664 |
| | 0.73 | 0.909 | 0.0658 |
| | 0.76 | 0.910 | 0.0655 |
| | 0.79 | 0.913 | 0.0648 |
| | 0.82 | 0.915 | 0.0649 |
| | 0.85 | 0.917 | 0.0643 |
| | 0.87 | 0.921 | 0.0687 |
| | 0.90 | 0.923 | 0.0671 |
| | 0.93 | 0.921 | 0.0678 |
| | 0.95 | 0.920 | 0.0616 |
| | 0.98 | 0.922 | 0.0742 |
| | 1.01 | 0.923 | 0.0687 |
| | 1.04 | 0.924 | 0.0728 |
| | 1.07 | 0.925 | 0.0704 |
| | 1.09 | 0.926 | 0.0738 |
| | 1.12 | 0.926 | 0.0773 |
| | 1.15 | 0.926 | 0.0745 |
| | 1.18 | 0.927 | 0.0811 |
| | 1.21 | 0.927 | 0.0785 |
| | 1.23 | 0.927 | 0.0747 |
| | 1.26 | 0.927 | 0.0795 |
| | 1.29 | 0.927 | 0.0726 |
| | 1.32 | 0.928 | 0.0731 |
| | 1.35 | 0.928 | 0.0772 |
| | 1.37 | 0.927 | 0.0715 |
| | 1.39 | 0.929 | 0.0727 |
| | 1.41 | 0.935 | 0.0733 |
| | 1.43 | 0.951 | 0.0771 |
| | 1.45 | 0.965 | 0.0713 |
| | 1.47 | 0.979 | 0.0744 |
| | 1.50 | 0.993 | 0.0782 |
| | 1.52 | 1.002 | 0.0690 |

In FIG. 2 the following nomenclature are used
[symbol] Normalised Cumulative Silicon Conversion for Example 1
[symbol] Cumulative Silicon Conversion for Example 2 relative to maximum Cumulative Silicon Conversion for Example 1
[symbol] Limits of data for Example 1
[symbol] Limits of data for Example 2
[symbol] Normalised T/D ratio for Example 1
[symbol] T/D ratio for Example 2 relative to maximum T/D ratio for Example 1

The results for Example 2, shown in Table 1 and FIG. 2 show how maintaining cumulative silicon conversion at 92% of the maximum cumulative silicon conversion attained in Example 1 (Difference “A”) gives a stable T/D Ratio at about 60% of the maximum T/D Ratio attained in Example 1 (Difference “B”) for at least 50% more silicon reacted than in Example 1 (Difference “C”).

It is surprising that Example 2 shows superior instantaneous and overall T/D ratio results compared to the process in Example 1 when both reactions are taken to the same level of cumulative silicon conversion. It would be expected that a similar T/D ratio would be achieved at similar cumulative conversion. However Example 2 demonstrates a T/D ratio of 0.07 at the same cumulative silicon conversion as Example 1, which achieves a T/D ratio of 0.13. Furthermore, it was unexpectedly found that reactors utilizing low silicon particle sizes can not achieve sufficient purging of contact mass by elutriation alone but that the use of a direct purge of contact mass in addition to elutriation enables the T/D ratio to be maintained below 0.35 for extended periods of time.

1. A process for the preparation of organohalosilanes or halosilanes, the process comprising:
I providing a fluidised bed reactor having an entrance and an exit;
II charging the fluidised bed reactor with the following ingredients:
i comminuted silicon;
ii at least one catalyst for a Direct Process reaction, provided that when HCl is fed to the reactor in step (III) no catalyst is added;
iii at least one promoter for the Direct Process reaction, provided that when HCl is fed to the reactor in step (III) no promoter is added;
III thereafter, providing an organohalide or hydrogen halide to the reactor to form a fluidised bed in the reactor;
IV allowing the ingredients to interact and react to produce organohalosilanes or halosilanes at a desired ratio and at a desired rate;
V enabling the organohalosilanes or halosilanes to leave the fluidised bed reactor whereby the organohalosilanes or halosilanes and unreacted organohalide or hydrogen chloride elutriate a proportion of the contact mass;
VI periodically or continuously removing contact mass from the fluidised bed reactor by direct removal at any location from beneath the surface of the fluidised bed using gravitational or differential pressure techniques;
VII replacing the contact mass removed in steps (V) and (VI) with fresh silicon; and
VIII reintroducing the removed contact mass from step (VI) to the fluidized bed reactor.

2. A process for producing organohalosilanes or halosilanes in a fluidised bed reactor, from silicon-containing contact mass, comprising removing silicon-containing contact mass that has been used in said reactor by
I elutriation in an unreacted organohalide or hydrogen halide and/or organohalosilane or halosilane (respectively) product stream and
II direct removal using gravitational or pressure differential methods and replacing the removed silicon-containing contact mass with fresh silicon fed to the reactor; and
reintroducing the removed contact mass to the fluidized bed reactor.

3. (canceled)

4. A process in accordance with claim 1 characterised in that, when preparing organohalosilanes, catalyst and/or promoter is introduced together with the fresh silicon.

5. A process in accordance with claim 3 characterised in that when preparing organohalosilanes, the silicon-containing contact mass contains catalyst and/or promoter.

6. A process in accordance with claim 1 characterized in that the organohalide is an alkyl halide.

7. A process in accordance with claim 1 wherein the silicon particle size is up to 150 μm.

8. A process in accordance with claim 1 wherein the catalyst is a copper catalyst, selected from one or more of elemental copper such as granular copper powder and stamped copper, copper alloys such as Cu—Zn, Cu—Si and Cu—Sb, and copper compounds such as cuprous oxide, cupric oxide, and copper halides.

9. A process in accordance with claim 8 wherein, when required, 0.1 to 10 parts, of the copper catalyst is used per 100 parts by weight of the metallic silicon powder in the reactor charge.

10. A process in accordance with claim 1 wherein the promoter for the Direct Process reaction, when used, is selected from phosphorous, phosphorous compounds, zinc, zinc compounds, tin, tin compounds, antimony, antimony compounds and arsenic and arsenic compounds cesium and cesium compounds and mixtures thereof.

11. A process in accordance with claim 1 wherein a cumulative silicon conversion in the range of from 70% to about 95% is maintained through removal of a portion of the contact mass during the continuous phase of the process while fresh silicon is still being fed to the reactor.

12. A process in accordance with claim 1 wherein the contact mass or metallic silicon powder may be heated for a certain time in an inert atmosphere at a temperature of up to 350° C., before it is subject to reaction.

13. A process in accordance with claim 1 wherein the fluidised bed can be fluidised using the organohalide or hydrogen halide as the fluidizing media or using a mixture of the alkyl halide or hydrogen halide with an inert gas as the fluidizing media.

14. A process in accordance with claim 13 wherein the inert gas is selected from nitrogen gas, helium gas, and argon gas and mixtures thereof.

15. A process in accordance with claim 1 wherein a near 100% overall silicon conversion is approached by means of returning previously removed silicon containing solid portions late in the continuous phase of the process.

16. A process in accordance with claim 1 characterized in that a mixture of both fresh silicon containing mass and removed silicon containing contact mass is introduced onto the fluidised bed reactor to replace removed silicon containing contact mass.

17. A process for the preparation of organohalosilanes or halosilanes, the process comprising:
I providing a fluidised bed reactor;
II charging the fluidised bed reactor with the following ingredients:
i comminuted silicon;
ii at least one catalyst for a Direct Process reaction, provided that when HCl is fed to the reactor in step (III) no catalyst is added;
iii at least one promoter for the Direct Process reaction, provided that when HCl is fed to the reactor in step (III) no promoter is added; to form a contact mass;
III providing an organohalide or hydrogen halide to the reactor to form a fluidised bed in the reactor;
IV allowing the ingredients to interact and react to produce organohalosilanes or halosilanes;
V enabling the organohalosilanes or halosilanes to leave the fluidised bed reactor whereby the organohalosilanes or halosilanes and unreacted organohalide or hydrogen chloride elutriate a proportion of the particulate contact mass;
VI periodically or continuously removing contact mass from the fluidised bed reactor by direct removal using gravitational or differential pressure techniques;
VII replacing the contact mass removed in steps (V) and (VI) with fresh silicon; and
VIII reintroducing the removed contact mass from step (VI) to the fluidized bed reactor

18-20. (canceled)

21. A process in accordance with claim 2 characterised in that, when preparing organohalosilanes, catalyst and/or promoter is introduced together with the fresh silicon.

22. A process in accordance with claim 2 characterised in that when preparing organohalosilanes, the silicon-containing contact mass contains catalyst and/or promoter.

23. A process in accordance with claim 2 wherein a near 100% overall silicon conversion is approached by means of returning previously removed silicon containing solid portions late in the continuous phase of the process.

24. A process in accordance with claim 17 wherein a near 100% overall silicon conversion is approached by means of returning previously removed silicon containing solid portions late in the continuous phase of the process.
